(19) United States
(12) Patent Application Publication
(10) Pub. No.: US 2008/0274039 A1
(43) Pub. Date: Nov. 6, 2008

(54) Integrated electrochemical and thermochemical renewable energy production, storage, distribution and recycling system

(76) Inventor: Mark Alen Shirk, (US)

Correspondence Address: Law Office of Wendell J. Jones;PMB 441, 555 Bryant Avenue, Palo Alto, CA, 94301, US

(21) Appl. No.: 12/072,848

(22) Filed: Feb. 27, 2008

Related U.S. Application Data
(60) Provisional application No. 60/904,130, filed on Feb. 27, 2007.

(51) Int. Cl. C01B 5/00; B01D 17/06

(52) U.S. Cl. 423/580.1; 204/194

(57) ABSTRACT

A first aspect of the present invention is a self-contained electrolysis process. The process includes utilizing a cryogenic cogeneration process to extract a liquid from an atmospheric medium, passing a current through the liquid, and separating at least one chemical element from the liquid. A second aspect of the present invention is a self-contained electrolysis apparatus. The apparatus includes cryogenic cogeneration means for extracting a liquid from an atmospheric medium, electrical means for passing a current through the liquid and separating means for separating at least one chemical compound from the liquid. A third aspect of the present invention is a method and system of removing at least one element from a chemical compound. The method and system include utilizing a cryogenic cogeneration process to remove the at least one element from the chemical compound.

### CROSS REFERENCE TO RELATED APPLICATION(S)

This application is related to and claims priority from U.S. Provisional Patent Application Ser. No. 60/904,130, filed Feb. 27, 2007.

### BACKGROUND

### Hydrogen Production

Hydrogen has been touted as an environmentally friendly wonder fuel that can be used in vehicles and burns to produce only water as a by product. Hydrogen production is a large and growing industry. Globally, some 50 million metric tons of hydrogen, equal to about 170 million tons of oil equivalent, were produced in 2004. The growth rate is around 10% per year. Within the United States, 2004 production was about 11 million metric tons (MMT), an average power flow of 48 gigawatts. As of 2005, the economic value of all hydrogen produced worldwide is about $135 billion per year.

There are two primary uses for hydrogen today. About half is used to produce ammonia (NH₃) via the Haber process, which is then used directly or indirectly as fertilizer. The other half of current hydrogen production is used to convert heavy petroleum sources into lighter fractions suitable for use as fuels. This latter process is known as hydrocracking. Hydrocracking represents an even larger growth area, since rising oil prices encourage oil companies to extract poorer source material, such as tar sands and oil shale. The scale economies inherent in large-scale oil refining and fertilizer manufacture make possible on-site production and “captive” use. Smaller quantities of “merchant” hydrogen are manufactured and delivered to end users as well.

Additionally, it is possible that fuel cells, using hydrogen as a fuel, will be able to replace most internal combustion engines and at the same time will solve most grid load balancing needs. It will do this by allowing “storage” of electrical energy in a grid of plug-in automobiles, which will be available to store excess energy as hydrogen, and offering it to the electrical grid as needed, after conversion in fuel cells. Hydrogen in this sense would act like a chemical battery and would essentially replace battery technology in electrical hybrid cars.

Although hydrogen fuel cells do not emit harmful gases into our atmosphere but other hazardous conditions exist due to the extremely explosive properties of hydrogen. Also, it is not economically efficient to completely modify our infrastructure to make our society dependent on hydrogen, since present technology requires costly energy consumption to liquify the hydrogen.

### Carbon Capture

About 85% of the world's commercial energy needs are currently supplied by fossil fuels. Carbon capture and storage is an approach to mitigate global warming by capturing carbon dioxide from large point sources such as fossil fuel power plants and storing it instead of releasing it into the atmosphere. Although CO₂ has been injected into geological formations for various purposes, the long term storage of CO₂ is a relatively untried concept and as yet no large scale power plant operates with a full carbon capture and storage system.

CCS applied to a modern conventional power plant could reduce CO₂ emissions to the atmosphere by approximately 80-90% compared to a plant without CCS. Capturing and compressing CO₂ requires much energy and would increase the fuel needs of a plant with CCS by about 11-40%. These and other system costs are estimated to increase the cost of energy from a new power plant with CCS by 21-91%. These estimates apply to purpose-built plants near a storage location: applying the technology to preexisting plants or plants far from a storage location could be more expensive.

Consequently, the technology of CCS would enable the world to continue to use fossil fuels but with much reduced emissions of CO₂, while other low-CO₂ energy sources are being developed and introduced on a large scale. In view of the many uncertainties about the course of climate change, further development and demonstration of CCS technologies is a prudent precautionary action.

### SUMMARY

Varying embodiments of the present invention include a self-contained electrolysis process and an apparatus associated therewith. In an embodiment, a cryogenic cogeneration process is employed in conjunction with an atmospheric medium to separate desired chemical compounds via electrolysis for storage and/or future use. Consequently, through the use of the present inventive concepts, desired chemical compounds (e.g. hydrogen, CO₂,) can be capture in an effective and cost efficient manner.

A first aspect of the present invention is a self-contained electrolysis process. The process includes utilizing a cryogenic cogeneration process to extract a liquid from an atmospheric medium, passing a current through the liquid, and separating at least one chemical element from the liquid.

A second aspect of the present invention is a self-contained electrolysis apparatus. The apparatus includes cryogenic cogeneration means for extracting a liquid from an atmospheric medium, electrical means for passing a current through the liquid and separating means for separating at least one chemical compound from the liquid.

A third aspect of the present invention is a method and system of removing at least one element from a chemical compound. The method and system include utilizing a cryogenic cogeneration process to remove the at least one element from the chemical compound.

Other aspects and advantages of the present invention will become apparent from the following detailed description, taken in conjunction with the accompanying drawings, illustrating by way of example the principles of the invention.

### BRIEF DESCRIPTION OF DRAWINGS

The accompanying drawings, which are incorporated in and constitute a part of the specification, illustrate varying embodiments of the inventive concepts and, together with a general description given above and the detailed description of the varying embodiments given below, serve to explain the principles of the invention.

FIG. 1 shows a cryogenic cogeneration system in accordance with an embodiment of the present invention.

FIGS. 2-1 and 2-2 shows the system in conjunction with varying embodiments of the present invention.

FIG. 3 show an overview of the integrated electrochemical and thermochemical renewable energy production, storage, distribution and recycling system in conjunction with an automated computer control network.

### DETAILED DESCRIPTION

The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

Varying embodiments of the present invention include a self-contained electrolysis process and an apparatus associated therewith. In an embodiment, a cryogenic cogeneration process/system is employed in conjunction with an atmospheric medium to separate desired chemical compounds via electrolysis for storage and/or future use. Consequently, through the use of the present inventive concepts, desired chemical compounds (e.g. hydrogen, CO₂,) can be capture in an effective and cost efficient manner.

### Hydrogen Production

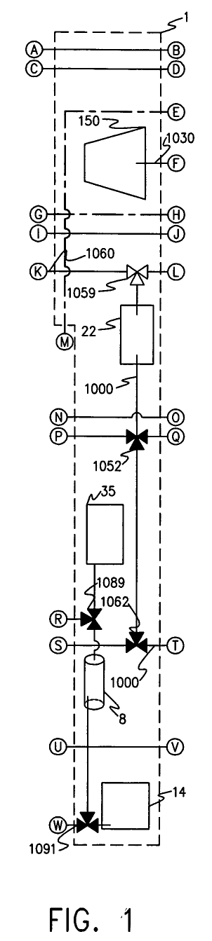

FIG. 1 shows a cryogenic cogeneration system 1 in conjunction with an embodiment. The system 1 includes a liquid receiver 8, a liquid subcooler 14, a super heater compressor 22, a condenser 35 and an expansion engine 150. In an embodiment, the system 1 converts energy from an external heat source medium 1000 into mechanical and/or electrical energy. For a further description of this exemplary system, reference may be had to U.S. patent application Ser. No. 11/100,197, filed Apr. 5, 2005, entitled “Cryogenic Cogeneration System”, which is incorporated herein by reference.

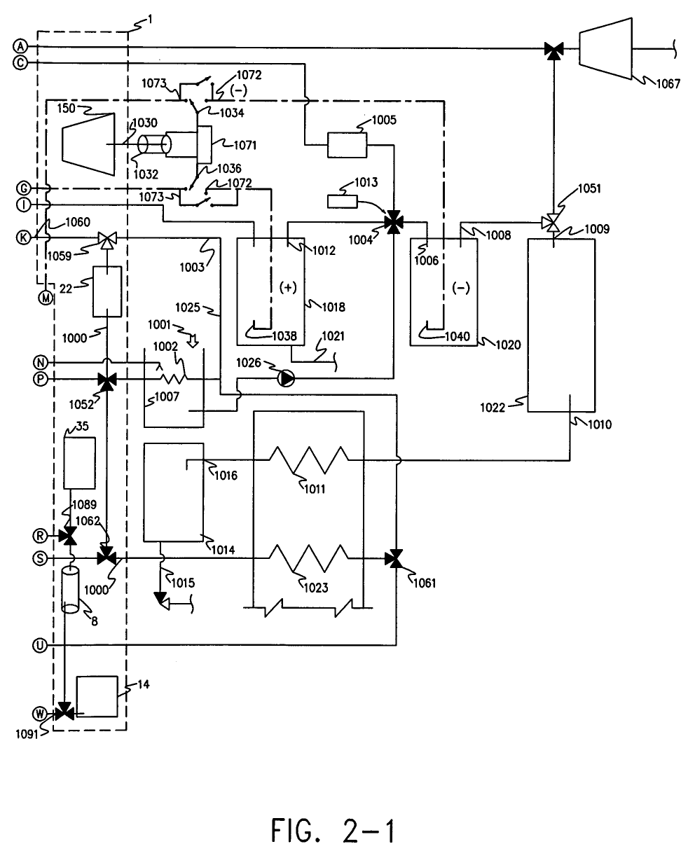

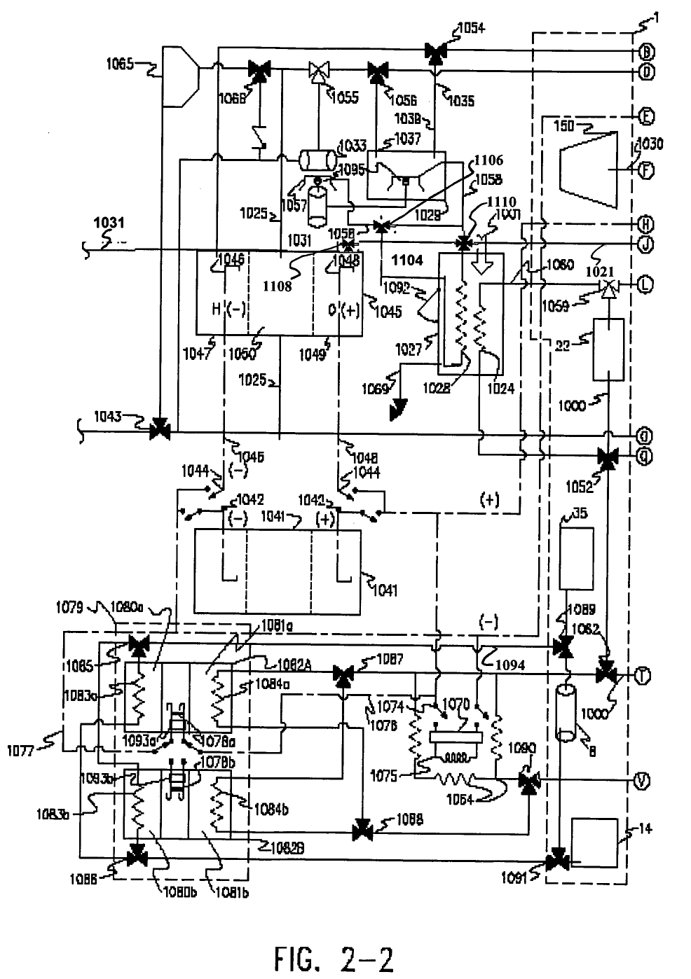

Please refer now to FIGS. 2-1 and 2-2. Accordingly, the electrolysis process preferably begins by chilling heat source medium 1000, via the superheater compressor 22. Once chilled, the medium 1000 is piped through distribution valve 1059 via supply piping route 1003 and piping and apparatuses 1025, into optional atmospheric vapor extraction coil 1002. Vapor extraction coil 1002 preferably absorbs desired electrolyte from vapor 1001 via thermally conductive contact with vapor 1001. The condensed/frozen vapor 1001 is then stored as ice and/or as liquid (e.g. water) via gravity flow into liquid electrolyte supply tank 1007.

A liquid electrolyte pressure pump 1026 draws the ice and/or liquid 1001 to central electrolyte supply distributor 1004. Here a conductive solvent injection system 1013 and a vaporized electrolyte steam Supply tank 1005 collaborate to distribute negatively charged anions to ion supply 1012 in anode tank 1018 and positively charged cations to ion supply 1006 in cathode tank 1020. Here, the desired element gas (e.g. hydrogen) can be separated from the liquid molecule/compound (e.g. water).

Accordingly, the hydrogen gas exits cathode tank 1020 via discharge exit 1008 and distribution valve 1051 to a gas turbine 1066 via valve 1067 and/or to a storage tank 1022 via supply line 1009. Hydrogen gas is subsequently discharged from storage tank 1022 via discharge exit 1010 to a heat rejection coil 1011 to condense/freeze/sublime the hydrogen and fill storage tank 1014 at supply tank entrance 1016. The hydrogen can then be removed from storage tank 1014 via discharge exit 1015.

In an embodiment, expansion engine 150 provides power to turn drive shaft 1030 that is coupled to an electrical generator 1032 and rectifier 1071. The electrical generator 1032 can be a direct current (DC) generator or an alternating current (AC) generator. The negatively charged (electron excessive) pole 1034 of generator 1032 (or Optional Rectifier 1071) feeds the line side of electrolysis cell 1072 to polarize electrolytic cathode electrode 1040. The positively charged (electron deficient) pole 1036 of generator 1032 (or Optional Rectifier 1071) feeds the line side of electrolysis cell 1072 to polarize electrolytic anode electrode 1038 to facilitate the correlated above-described electrolysis process.

### Voltaic Process

In an alternate embodiment, a self-contained voltaic process is implemented. Here, the hydrogen from storage tank 1009 and/or cathode tank 1020 are routed by the distribution valve 1051 to anode fill tank 1047 via anode electrode 1046 of voltaic fuel cell 1045. The voltaic fuel cell 1045 also includes a cathode fill tank 1049 for storing cathodes routed to the cathode electrode 1048 via storage tank 1018. The pertinent re-dox reaction with the voltaic fuel cell electrolyte 1050 takes place and desired ions/reactant(s)/element (e.g. oxygen) from the cathode fill tank 1049 re-bond and form gas and/or liquid (e.g. steam/water) that can exit via piping 1025 through valves 1055 and 1056 to be distributed per demand conditions.

Alternatively, the steam/water can be recycled back into original reduced forms via re-entering the electrolysis system as a gas through a steam supply tank 1005 and/or the steam reforming tank 1037 as distributed by steam feeder valve 1056 and/or as a liquid via the bottom exit of 1050 and re-entering supply tank 1007 through piping 1025. Steam can optionally travel via supply distribution valve 1066 and perform work output via steam expansion engine turbine 1065.

### Liquefaction

Liquefaction of gases includes a number of processes used to convert a gas into a liquid state. The processes are used for scientific, industrial and commercial purposes. Many gases can be put into a liquid state at normal atmospheric pressure by simple cooling; a few, such as carbon dioxide, require pressurization as well. Liquefaction is used for analyzing the fundamental properties of gas molecules (intermolecular forces), for storage of gases and in refrigeration and air conditioning.

Accordingly, in an alternate embodiment, a liquefaction process can be implemented. The process begins whereby the desired element e.g. Hydrogen, exits hydrogen production tank 1029 through distribution valve 1054 via hydrogen outlet 1035. The hydrogen then proceeds through to gas turbine 1066 via valve for 1067 and/or storage tank 1009. Next, the hydrogen exits storage tank 1009 via discharge exit 1010 to become in thermally conductive contact with heat rejection coil 1011. Once in thermally conductive contact with the heat rejection coil 1011, the hydrogen liquefies to fill storage tank for 1014 through supply entrance 1016.

Although the above-described embodiments are described in the context of hydrogen production, one of ordinary skill in the art will readily recognize that a variety of different chemical elements can be produced with this system while remaining spirit and scope of the present inventive concepts.

Self Contained Electricity Generation, Distribution and/or Storage Process

In an alternate embodiment, a self-contained electricity generation, distribution and storage process is implemented. The process begins whereby expansion engine 150 from cryogenic cogeneration system 1 provides power to turn drive shaft 1030 that is coupled to electrical generator 1032 with or without the option of utilizing rectifier 1071. The negatively charged (electron excessive) pole 1034 and the positively charged (electron deficient) pole 1036 of rectifier 1071 feed the line sides of electrical switching to battery storage 1073 through switch 1042 to facilitate the charging of storage battery(s) 1041.

In an alternate process, expansion engine 150 from cryogenic cogeneration system 1 provides power to turn drive shaft 1030 that is coupled to electrical generator 1032 with rectifier 1071. The negatively charged (electron excessive) pole 1034 and the positively charged (electron deficient) pole 1036 of rectifier 1071 feed the line sides of switch 1073 through switches 1076 and 1077 to facilitate the alternating and/or direct current power load to/from Supplemental Refrigeration/Thermalelectric System 1078(a,b . . . ) within a parallel array of Supplemental Refrigeration/Current Generation System(s) 1079. This array can include but is not be limited to Dilution Cryocooler(s), Adiabatic Demagnetization Refrigerators, Pulse Tubes, Brayton Cycles, Claude Cycles, Thermal Electric Refrigerators, Vortex Tubes, Dry Ice Refrigerators, and Stirling Engines which could include the utilization of Optional Sequenced Inverter 1093(a,b . . . ).

Direct Current

In another embodiment, expansion engine 150 from cryogenic cogeneration system 1 provides power to turn drive shaft 1030 that is coupled to electrical generator 1032 with rectifier 1071. The negatively charged (electron excessive) pole 1034 and the positively charged (electron deficient) pole 1036 of rectifier 1071 feed the line sides of switch 1073 through power distribution switch 1074 to supply direct current to electrical power demand load 1075 (e.g. electric motor, transformer, etc).

Alternating Current

In another embodiment, expansion engine 150 from cryogenic cogeneration system 1 provides power to turn drive shaft 1030 that is coupled to electrical generator 1032 with rectifier 1071. The negatively charged (electron excessive) pole 1034 and the positively charged (electron deficient) pole 1036 of rectifier 1071 feed alternating current to the line sides of switch 1073 through power distribution switch 1074 to supply alternating current to electrical power demand load 1075 (e.g. electric motor, transformer, etc).

Voltaic Fuel Cell

In another embodiment, Voltaic (Fuel) Cell anode electrode 1046 and Voltaic (Fuel) Cell cathode electrode 1048 feed direct current power via switch 1044 through switch 1074 for supply of direct current demand load 1075 or via inverter 1070 for supply of alternating current to demand load 1075. Additionally, Voltaic (Fuel) Cell anode electrode 1046 and Voltaic (Fuel) Cell cathode electrode 1048 feed direct current power via switch 1044 to facilitate the charging of Storage Battery(s) 1041.

Furthermore, the distribution of electrical power demand load 1075 can be cryogenically cooled to reduce/eliminate resistance attributed to counter electromotive force via thermal contact with Superconducter Cryogenic Cooling Medium/Heat Exchanger 1064 contained within Superconducter Cryogenic Cooling Loop for Electrical Power Distribution Line Feeders 1063. After Medium 1064 absorbs heat from load 1075, the medium returns as a heat source medium 1000 via valve 1062. The medium then rejects heat and becomes re-chilled via superheater compressor 22 to be re-supplied via valves 1061 and 1090 back to complete Loop 1063.

Integration of the Cryogenic Cogeneration System with a Parallel Array of Supplemental Refrigeration and/or Thermal Electrical Current Generation System(s)

This integration process begins by chilling heat source medium 1000, via superheater compressor 22, from cryogenic cogeneration system 1. The medium 1000 is discharged though distribution valve 1059, where the chilled medium 1000 is routed to piping route 1003 via distribution valves 1090 and 1061. Chilled medium 1000 then proceeds through distribution valve 1088 to the calculated pertinent thermal energy exchanger 1084(a,b . . . ) which will absorb thermal energy from the thermal energy exchanger for supplemental refrigeration system 1081(a,b . . . ). Medium 1000 then returns back to superheater compressor 22 via distribution valves 1087, 1062 and 1052 to complete the integration loop.

Additionally, temperature and/or thermal differentials between 1081(a,b . . . ) and 1080(a,b . . . ) at least partially attributed to the aforementioned integration process may generate a current that can travel via switching 1076, 1077, and 1042 to supplement the charging of battery storage systems 1041 and/or other appropriate electrical power load demands.

Cryogenic Cogeneration System Interaction with Supplemental Refrigeration/Current Generation System

Condenser to Subcooler

In an embodiment, the cryogenic cogeneration system 1 can interact with the Supplemental Refrigeration/Current Generation System(s) 1080 (a,b . . . ) to create a temperature difference in order to supplement the efficient operation thereof. Here, the condenser 35 rejects heat to heat sink medium 1094 which will exit condenser 35 through distribution valve 1089 via distribution valve 1085 to enter the calculated pertinent thermal energy exchanger 1080(a,b . . . ) which will absorb heat from medium 1094 as it circulates through the calculated pertinent thermal energy rejecter coil 1083(a,b . . . ). It then exits as a chilled/sub-cooled medium via distribution valve 1086 and then proceeds through distribution valve 1091 to feed liquid sub-cooler 14 and/or liquid receiver 8.

Receiver to Subcooler

In an alternate embodiment, liquid receiver 8 rejects heat to heat sink medium 1094 which exits receiver 8 through distribution valve 1089 via distribution valve 1085 to enter the calculated pertinent thermal energy exchanger 1080(a,b . . . ) which will absorb heat from medium 1094 as it circulates through the calculated pertinent thermal energy exchanger rejecter coil 1083(a,b . . . ) to exit as a chilled/subcooled medium via distribution valve 1086 then through distribution Valve 1091 to feed liquid sub-cooler 14 and/or liquid receiver 8.

### Carbon Capture

In another embodiment, the cryogenic cogeneration system 1 can be employed to remove carbon from fossil fuel. This can be accomplished pre-combustion or post-combustion.

### Pre-Combustion

In the pre-combustion embodiment, the process begins whereby fossil fuel 1031 and/or discharge for desired gas element (e.g. Oxygen) 1021 flows via valve 1108 and/or distribution valve 1110 to gas emission capture tank 1027 where waste gas separator coil 1028 is employed to remove undesired elements through thermally conductive contact with carbon emission extraction coil 1024. Fuels 1031 and 1021 can then re-circulate back via valve 1106 to supply burners 1095 for cleaner combustion. This process can be applied to all types of combustion systems.

### Post-Combustion

In the post-combustion embodiment, make up steam from boiler 1033 enters and supply steam reforming tank via 1037 as distributed by feeder valve 1056 to mix with fossil fuel 1031 via steam reforming tank entrance 1039 within steam reforming (Hydrogen Production) tank 1029.

Harmful emissions (e.g. carbon) can be captured from Steam Reforming Tank 1029 and/or Optional Steam Boiler 1033 and/or Burners 1095 preferably with extraction hood 1057 to be exhausted via distribution piping 1058 to injector 1028 and extraction coil 1024. The extraction coil 1024 then transfers absorbed heat into external heat source medium 1000, via thermally conductive contact. The medium 1000 then returns via circulation through distribution valve 1052 back to the superheater compressor 22.

Here, the medium 1000 is re-chilled and re-circulated via distribution valve 1059 to be routed back through loop 1060 and again through capture tank 1027. Processed product (e.g. liquid CO₂ and Dry Ice) can then be removed from capture tank exit 1069 and/or Dry Ice Dispenser door 1092.

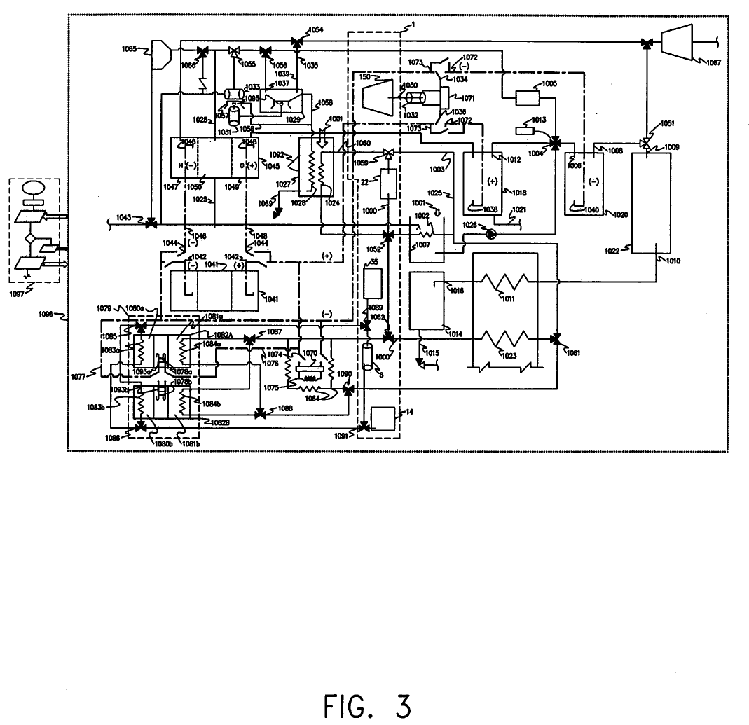

It should be noted that an automated computer control network may be implemented to control part and/or all of the aforementioned processes via the use of an indefinite number of electronic and/or electromechanical and/or pneumatic and/or hydraulic actuators, relays, and all other pertient parts and accessories of a complete control system. FIG. 3 show an overview of the integrated electrochemical and thermochemical renewable energy production, storage, distribution and recycling system 1096 in conjunction with an automated computer control network 1097.

Without further analysis, the foregoing so fully reveals the gist of the present inventive concepts that others can, by applying current knowledge, readily adapt it for various applications without omitting features that, from the standpoint of prior art, fairly constitute the characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A self-contained electrolysis process comprising:
utilizing a cryogenic cogeneration process to extract a liquid from an atmospheric medium;
passing a current through the liquid medium; and
separating at least one chemical element from the liquid.

2. The process of claim 1 wherein the cryogenic cogeneration process further comprises:
utilizing a vapor compression cycle to absorb heat from a heat source wherein the vapor compression cycle includes at least one subassembly for providing pressurization in an isovolumetric fashion;
utilizing a Rankine cycle in conjunction with the vapor compression cycle for energy transfer, for converting thermal energy to mechanical and/or electrical energy;
transferring latent thermal energy to and from said vapor compression cycle and said Rankine cycle in a simultaneous fashion; and
utilizing a substantial portion of said mechanical and/or electrical energy to provide power to an external workload.

3. The process of claim 1 wherein the liquid comprises water.

4. The process of claim 3 wherein the at least one chemical element comprises hydrogen.

5. The process of claim 3 wherein the atmospheric medium comprises air.

6. The process of claim 4 further comprising:
storing the hydrogen for future consumption.

7. The process of claim 4 further comprising:
transporting the hydrogen to a voltaic fuel cell.

8. A self-contained electrolysis apparatus comprising:
cryogenic cogeneration means for extracting a liquid from an atmospheric medium;
electrical means for passing a current through the liquid; and
separating means for separating at least one chemical element from the liquid.

9. The apparatus of claim 8 wherein cryogenic cogeneration means further comprising:
vapor compression cycle means to absorb heat from said heat source wherein the vapor compression cycle means includes at least one subassembly for providing pressurization in an isovolumetric fashion;
Rankine cycle means for energy transfer and to absorb heat from said heat source, said Rankine cycle means for converting thermal energy to mechanical and/or electrical energy, said Rankine cycle means being operably linked to said vapor compression cycle means;
energy transfer means for transferring latent thermal energy to and from said vapor compression cycle and said Rankine cycle in a simultaneous fashion; and
wherein a substantial portion of said mechanical and/or electrical energy is utilized to provide power to an external workload.

10. The apparatus of claim 8 wherein the liquid comprises water.

11. The apparatus of claim 8 wherein the at least one chemical element comprises hydrogen.

12. The apparatus of claim 8 wherein the atmospheric medium comprises air.

13. The apparatus of claim 11 further comprises:
storage means for storing the hydrogen.

14. The apparatus of claim 13 further comprising:
means for transporting the hydrogen to a voltaic fuel cell.

15. A method of removing at least one element from a chemical compound comprising:
utilizing a cryogenic cogeneration process to remove the at least one element from the chemical compound.

16. The method of claim 15 wherein the cryogenic cogeneration process further comprises:
utilizing a vapor compression cycle to absorb heat from a heat source wherein the vapor compression cycle includes at least one subassembly for providing pressurization in an isovolumetric fashion;
utilizing a Rankine cycle in conjunction with the vapor compression cycle for energy transfer, for converting thermal energy to mechanical and/or electrical energy;
transferring latent thermal energy to and from said vapor compression cycle and said Rankine cycle in a simultaneous fashion; and
utilizing a substantial portion of said mechanical and/or electrical energy to provide power to an external workload.

17. The method of claim 15 wherein the at least one element is a carbon-based element.

18. The method of claim 15 wherein the chemical compound is a pre-combustion fuel mixture.

19. The method of claim 15 wherein the chemical compound is a post-combustion fuel compound.

20. The method of claim 19 wherein the post-combustion fuel compound is flue gas.

21. A system for removing at least one element from a chemical compound comprising:
means for utilizing a cryogenic cogeneration process to remove the at least one element from the chemical compound.

22. The system of claim 21 wherein cryogenic cogeneration means further comprising:
vapor compression cycle means to absorb heat from said heat source wherein the vapor compression cycle means includes at least one subassembly for providing pressurization in an isovolumetric fashion;
Rankine cycle means for energy transfer and to absorb heat from said heat source, said Rankine cycle means for converting thermal energy to mechanical and/or electrical energy, said Rankine cycle means being operably linked to said vapor compression cycle means;
energy transfer means for transferring latent thermal energy to and from said vapor compression cycle and said Rankine cycle in a simultaneous fashion; and wherein a substantial portion of said mechanical and/or electrical energy is utilized to provide power to an external workload.

23. The system of claim 21 wherein the at least one element is a carbon-based element.

24. The system of claim 21 wherein the chemical compound is a pre-combustion fuel mixture.

25. The system of claim 21 wherein the chemical compound is a post-combustion fuel compound.

26. The system of claim 25 wherein the post-combustion fuel compound is flue gas.
